(19) United States
(12) Patent Application Publication
(10) Pub. No.: US 2013/0059518 A1
(43) Pub. Date: Mar. 7, 2013

(54) METHOD AND SYSTEM FOR CONTROLLING AN AIRCRAFT COMPONENT DURING A WATER LANDING

(71) Applicants: Carsten Biegemann, Jork (DE); Ugur Akin, Hamburg (DE); Julien Berbach, Hamburg (DE)

(72) Inventors: Carsten Biegemann, Jork (DE); Ugur Akin, Hamburg (DE); Julien Berbach, Hamburg (DE)

(73) Assignee: AIRBUS OPERATIONS GMBH, Hamburg (DE)

(21) Appl. No.: 13/635,955

(22) PCT Filed: Feb. 23, 2011
(86) PCT No.: PCT/EP2011/000884

§ 371 Date: Nov. 7, 2012

(30) Foreign Application Priority Data
Mar. 19, 2010 (DE) 10 2010 012 071.5

(51) Int. Cl. B64D 13/04; B64D 25/00

(52) U.S. Cl. 454/74; 244/129.4

(57) ABSTRACT

The invention relates to a system (10) for controlling a water landing of an aircraft comprising at least one detection device (12, 14, 16, 18), which is adapted to detect at least one signal suitable for recognizing an imminent water landing of the aircraft. A control unit (20) is adapted to receive the at least one signal suitable for recognizing an imminent water landing of the aircraft and to evaluate said signal on the basis of at least one predetermined recognition characteristic that characterizes a water landing of the aircraft. The control unit (20) is also adapted to control a closing device (24) associated with an opening (22) in such a way that in the event of a water landing of the aircraft the entry of water into an interior area of the aircraft through the opening (22) is prevented if the control unit (20) recognizes that a water landing of the aircraft is imminent on the basis of the at least one signal and the at least one recognition characteristic.

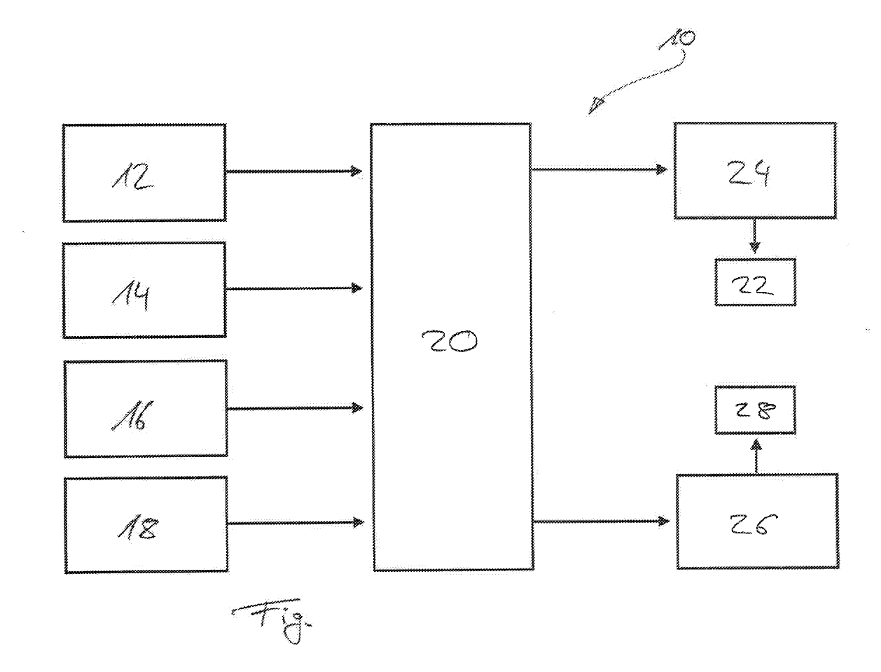

The invention relates to a method and a system for controlling an aircraft component during a water landing of an aircraft.

During a water landing of an aircraft the entry of water into the interior of the aircraft leads to an acceleration of the sinking of the aircraft and hence shortens the evacuation time for the aircraft passengers and the aircraft crew. The penetration of water into selected interior areas of the aircraft, such as the passenger cabin and the cockpit, or into areas, in which systems relevant to the evacuation of the aircraft are disposed, should moreover be prevented for as long as possible. In modern aircraft in the event of a water landing it is therefore customary, in response to a suitable signal indicating an imminent water landing, to close all of the openings formed in the fuselage of the aircraft below a flotation line of the aircraft, such as for example valve openings, ram air channel mouths or air outlet channel mouths, in order to prevent the entry of water into the interior of the aircraft through these openings. The signal indicating an imminent water landing is output to all of the affected aircraft systems manually by the pilots in the cockpit, for example by pressing a button.

The invention is geared to the object of indicating a method and a system for controlling an aircraft component during a water landing of an aircraft that reduce the burden on the pilots in the event of a water landing.

In a method according to the invention of controlling an aircraft component during a water landing of an aircraft at least one signal that is suitable for recognizing an imminent water landing of the aircraft is detected and transmitted to a control unit. The control unit evaluates the signal on the basis of at least one predetermined recognition characteristic that characterizes a water landing. The control unit, on the basis of the signal evaluation it carries out, is capable of recognizing that a water landing of the aircraft is imminent. In other words, the control method according to the invention comprises an automatic recognition of an imminent water landing of the aircraft.

If the control unit on the basis of the at least one signal and on the basis of the at least one recognition characteristic detects that a water landing of the aircraft is imminent, a closing device associated with an opening is controlled into a closing position. The opening that is to be closed by means of the closing device may be a valve opening, a mouth of a channel, for example of a ram air channel or an air outlet channel, and/or a door aperture. The opening may be an opening disposed in any position in the fuselage of the aircraft. However the opening may alternatively also be formed in a structural part that separates two interior areas of the aircraft from one another. The essential point is merely that by closing the opening in the event of a water landing of the aircraft the entry of water into an interior area of the aircraft through the opening is prevented. The control unit preferably activates a closing device that is adapted to close an opening disposed below a flotation line of the aircraft.

The control method according to the invention therefore enables not only an automatic detection of an imminent water landing of the aircraft but also the automatic initiation of measures, which in the event of a water landing of the aircraft prevent the entry of water into a selected interior area of the aircraft. The manual output by the pilots of a signal indicating an imminent water landing is therefore no longer necessary. In principle the control method may be confined to controlling only one closing device associated with a selected opening into a closing position in the event of a water landing of the aircraft, wherein the selected opening may be for example an opening with a large cross section of flow that is disposed in the fuselage of the aircraft below the flotation line. The control method may however alternatively provide the activation of a plurality of closing devices that are associated with a plurality of openings. For example, in the context of the control method according to the invention all of the openings formed in the fuselage of the aircraft below the flotation line may be closed.

By virtue of the control method according to the invention the burden on the pilots in the event of a water landing of the aircraft may be reduced. This enables the pilots to concentrate on the landing operation itself. Pilot error during the assessment of the operating situation of the aircraft as an operating situation preceding a water landing and during the manual output of the signal indicating an imminent water landing as well as unnecessary time delays during these processes may moreover be ruled out. In the event of a water landing the control method according to the invention therefore improves the safety of the persons situated on board the aircraft.

In the method according to the invention of controlling an aircraft component during a water landing of an aircraft a pressure generating system of the aircraft is preferably controlled in such a way that a pressure build-up in an aircraft area that is pressurized during normal operation of the aircraft is prevented if the control unit recognizes that a water landing of the aircraft is imminent. The pressure generating system may be part of an air conditioning system of the aircraft and/or a system that is independent of the air conditioning system of the aircraft. The control of the pressure generating system by the control unit may provide a limiting of the capacity or the disconnection of the pressure generating system. In an aircraft area that is pressurized during normal operation of the aircraft this prevents a build-up of pressure which cannot be controlled in the desired manner, as it is during normal operation of the aircraft, by opening air outlet valves formed in the fuselage of the aircraft because the air outlet valves in the event of a water landing of the aircraft have to remain closed to prevent water from penetrating into the interior of the aircraft through the valves.

In a preferred embodiment of the method according to the invention the control unit detects that a water landing of the aircraft is imminent on the basis of at least two predetermined recognition characteristics that characterize an imminent water landing of the aircraft, wherein the at least two recognition characteristics differ from one another. Taking more than one recognition characteristic into consideration when assessing the actual operating situation of the aircraft increases the reliability, with which an operating situation of the aircraft is recognized correctly as an operating situation preceding a water landing. If need be, the control unit may use two, three, four or more recognition characteristics to recognize that a water landing of the aircraft is imminent.

The signal that is used in the method according to the invention of controlling an aircraft component during a water landing of an aircraft is preferably a signal that is characteristic of the actual cruising altitude of the aircraft, a signal that is characteristic of the ambient pressure, a signal that is characteristic of the operating state of aircraft landing gear and/or a signal that is characteristic of the nature of the earth's surface below the aircraft. The signal that is characteristic of the actual cruising altitude of the aircraft may be for example a signal from the altimeter of the aircraft and indicate for example the geometric altitude of the aircraft, i.e. the distance of the aircraft from the ground. The signal that is characteristic of the ambient pressure is preferably a signal that is characteristic of the corrected static ambient pressure, i.e. the static pressure in the vicinity of the aircraft minus the influence of air turbulence and/or air movements. The ambient pressure decreases with increasing altitude and is therefore a measure of the cruising altitude. The corrected static ambient pressure enables a reliable assessment of the minimum cruising altitude of the aircraft. The signal that is characteristic of the operating state of the aircraft landing gear preferably indicates whether the landing gear is retracted or extended and may be an operating state signal transmitted by a landing gear control unit but also a video signal captured by an optical camera. The signal that is characteristic of the nature of the earth's surface below the aircraft may be for example a video signal captured by an optical camera, the signal of a water-sensitive radar device and/or the signal of a thermal imaging camera.

The predetermined recognition characteristic that characterizes a water landing may be a recognition characteristic of a drop below a predetermined cruising altitude of the aircraft, a recognition characteristic of a rise above a predetermined ambient pressure, a recognition characteristic of retracted aircraft landing gear and/or a recognition characteristic of a body of water below the aircraft. For example a measured cruising altitude of the aircraft is recognized as a cruising altitude that characterizes an imminent water landing if the measured cruising altitude drops below a predetermined threshold value of for example 2000 feet (ca. 610 m). In a similar manner, for example a measured ambient pressure is recognized as an ambient pressure that characterizes an imminent water landing if the measured ambient pressure rises above a predetermined threshold value of for example 571 hPa, this corresponding to a cruising altitude of the aircraft of ca. 15,000 feet (4572 m). Taking the ambient pressure as well as the cruising altitude into consideration enables a specific redundancy when assessing an operating situation of the aircraft as an operating situation preceding a water landing and therefore increases the certainty that an operating situation of the aircraft will not be falsely recognized as an operating situation preceding a water landing.

When considering the operating state of the aircraft landing gear, retracted landing gear, particularly in connection with the presence of further recognition characteristics, may be evaluated as an indication of an imminent water landing of the aircraft. Recognizing whether the landing gear is retracted may be effected on the basis of an operating state signal transmitted by a landing gear control unit or by means of corresponding evaluation of a video signal captured by an optical camera. For the evaluation of the video signal suitable image recognition software may be used. In a similar manner a video signal captured by an optical camera, a radar signal and/or a signals of a thermal imaging camera may also be evaluated by means of suitable software in order to recognize whether a body of water is situated below the aircraft. If desired, it is possible to recognize on the basis of only one suitable signal, for example a video signal, that the landing gear is retracted and that a body of water is situated below the aircraft. In the method according to the invention the number of suitable signals detected to recognize an imminent water landing of the aircraft and the number of predetermined recognition characteristics characterizing an imminent water landing of the aircraft therefore need not necessarily be equal.

A system according to the invention for controlling an aircraft component during a water landing of an aircraft comprises at least one detection device, which is adapted to detect at least one signal suitable for recognizing an imminent water landing of the aircraft. A control unit is adapted to receive the at least one signal and evaluate said signal on the basis of at least one predetermined recognition characteristic that characterizes a water landing of the aircraft. The control unit is further adapted to control a closing device associated with an opening in such a way that in the event of a water landing of the aircraft the entry of water into an interior area of the aircraft through the opening is prevented if the control unit recognizes that a water landing of the aircraft is imminent on the basis of the at least one signal and the at least one recognition characteristic.

In a preferred embodiment of the system for controlling an aircraft component during a water landing of an aircraft the control unit is further adapted to control a pressure generating system of the aircraft in such a way that a pressure build-up in an aircraft area that is pressurized during normal operation of the aircraft is prevented if the control unit recognizes that a water landing of the aircraft is imminent.

The control unit is preferably further designed to recognize that a water landing of the aircraft is imminent on the basis of at least two specified recognition characteristics that characterize an imminent water landing of the aircraft, wherein the at least two recognition characteristics differ from one another.

The signal suitable for recognizing an imminent water landing of the aircraft may be a signal that is characteristic of the actual cruising altitude of the aircraft, a signal that is characteristic of the corrected static ambient pressure, a signal that is characteristic of the operating state of the aircraft landing gear and/or a signal that is characteristic of the nature of the earth's surface below the aircraft.

The predetermined recognition characteristic that characterizes a water landing of the aircraft may be a recognition characteristic of a drop below a predetermined cruising altitude of the aircraft, a recognition characteristic of a rise above a predetermined corrected static ambient pressure, a recognition characteristic of retracted aircraft landing gear and/or a recognition characteristic of a body of water below the aircraft.

There now follows a detailed description of a preferred embodiment of the invention with reference to the accompanying figure, which shows a diagrammatic representation of a system for controlling an aircraft component during a water landing of an aircraft.

A system 10 for controlling an aircraft component during a water landing of an aircraft comprises four detection devices 12, 14, 16, 18, each of which is adapted to detect a signal suitable for recognizing an imminent water landing of the aircraft. A first detection device 12 is configured in the form of a radar altimeter and is adapted to detect and output a signal that is characteristic of the actual cruising altitude of the aircraft. The signal that is characteristic of the actual cruising altitude of the aircraft in this case represents the geometric altitude of the aircraft and denotes the distance of the aircraft from the ground. A second detection device 14 is configured in the form of a pressure measuring device, which is integrated into an air data inertial reference system of the aircraft, and is adapted to detect and output a signal that is characteristic of the corrected static ambient pressure. The signal that is characteristic of the corrected static ambient pressure denotes the static pressure prevailing in the vicinity of the aircraft minus the influence of air turbulence and/or air movements. This signal enables the reliable assessment of a lower limit for the measure of altitude between aircraft and the earth's surface. A third detection device 16 is configured in the form of an operating state sensor of a landing gear control unit of the aircraft and is adapted to detect and output a signal that is characteristic of the operating state of the aircraft landing gear. The signal that is characteristic of the operating state of the aircraft landing gear indicates in particular whether the landing gear is extended or retracted. Finally a fourth detection device 18 is configured in the form of a camera, which is integrated into a terrain awareness system of the aircraft, and is adapted to detect a video signal of the surrounding area, i.e. of the earth's surface below the aircraft.

The system 10 for controlling an aircraft component during a water landing of an aircraft further comprises a control unit 20, which is adapted to receive the signals detected by the detection devices 12, 14, 16, 18 and evaluate said signals on the basis of four predetermined recognition characteristics that characterize a water landing of the aircraft. The first recognition characteristic is the dropping below a predetermined cruising altitude of the aircraft. The predetermined cruising altitude is 2000 feet (ca. 610 m). If the control unit 20, as a result of comparing the cruising altitude value measured by the first detection device 12 with the predetermined cruising altitude value, establishes that the aircraft has dropped below the predetermined cruising altitude of 2000 feet (ca. 610 m), the control unit 20 evaluates this as an indication of an imminent water landing. The second recognition characteristic is the rising above a predetermined corrected static ambient pressure. The predetermined corrected static ambient pressure is 571 hPa, this corresponding to a cruising altitude of the aircraft of ca. 15,000 feet (4572 m). If the control unit 20, as a result of comparing the ambient pressure value measured by the second detection device 14 with the predetermined ambient pressure value, establishes that the aircraft has dropped below the cruising altitude of 15,000 feet (4572 m), the control unit 20 evaluates this likewise as an indication of an imminent water landing. Taking the ambient pressure as well as the cruising altitude into consideration enables a redundant assessment of the cruising altitude of the aircraft and hence increases the certainty that an operating situation of the aircraft will not be falsely recognized as an operating situation preceding a water landing.

The third recognition characteristic is retracted aircraft landing gear, i.e. if the signal that is characteristic of the operating state of the aircraft landing gear indicates that the landing gear is retracted, even though the aircraft has dropped below the specified cruising altitude of 2000 feet (ca. 610 m) and even though the outcome of the comparison between the ambient pressure value measured by the second detection device 14 and the predetermined ambient pressure value is that the aircraft has dropped below the cruising altitude of 15,000 feet (4572 m), the control unit 20 evaluates the “landing gear retracted” operating state as a further indication of an imminent water landing. Finally the control unit 20 uses the recognition of a body of water situated below the aircraft as a fourth recognition characteristic of an imminent water landing. For this purpose, the image taken by the camera of the terrain awareness system is evaluated with the aid of suitable image recognition software. In the embodiment shown in the figure the control unit 20 evaluates an operating state of the aircraft as an operating state preceding a water landing only if the signals detected by the detection devices 12, 14, 16, 18 indicate that all four recognition characteristics are met.

In response to the automatic recognition of an imminent water landing of the aircraft by the control unit 20, the control unit 20 further provides for the automatic initiation of measures that increase safety during a water landing. In particular the control unit 20 controls into a closing position all of the closing devices 24 that are associated with openings 22, such as for example valve openings or air channel mouths, that are disposed in the fuselage of the aircraft below a flotation line. In the event of a water landing of the aircraft this prevents water from entering through the openings 22 into an interior area of the aircraft. The control unit 20 further disconnects a pressure generating system 26. In aircraft areas 28 that are pressurized during normal operation of the aircraft this prevents the build-up of a pressure that is higher than the ambient pressure and which, owing to the fact that air outlet valves disposed in the fuselage of the aircraft are closed, cannot be controlled, as during normal operation of the aircraft, by opening the air outlet valves 22.

1-10. (canceled)

11. Method of controlling an aircraft component during a water landing of an aircraft, comprising the steps:
detecting at least one signal suitable for recognizing an imminent water landing of the aircraft,
transmitting the at least one signal to a control unit,
evaluating the at least one signal on the basis of at least one predetermined recognition characteristic that characterizes a water landing,
controlling a closing device associated with an opening into a closing position in such a way that in the event of a water landing of the aircraft the entry of water into an interior area of the aircraft through the opening is prevented if the control unit recognizes that a water landing of the aircraft is imminent on the basis of the at least one signal and the at least one recognition characteristic.

12. Method according to claim 11,
characterized by the further step:
controlling a pressure generating system of the aircraft in such a way that a pressure build-up in an aircraft area that is pressurized during normal operation of the aircraft is prevented if the control unit recognizes that a water landing of the aircraft is imminent.

13. Method according to claim 11,
characterized in that the control unit recognizes that a water landing of the aircraft is imminent on the basis of at least two predetermined recognition characteristics that characterize an imminent water landing of the aircraft, wherein the at least two recognition characteristics differ from one another.

14. Method according to claim 11,
characterized in that the signal suitable for recognizing an imminent water landing of the aircraft is a signal that is characteristic of the actual cruising altitude of the aircraft, a signal that is characteristic of the ambient pressure, a signal that is characteristic of the operating state of aircraft landing gear and/or a signal that is characteristic of the nature of the earth's surface below the aircraft.

15. Method according to claim 11,
characterized in that the predetermined recognition characteristic that characterizes a water landing is a recognition characteristic of a drop below a predetermined cruising altitude of the aircraft, a recognition characteristic of a rise above a predetermined ambient pressure, a recognition characteristic of retracted aircraft landing gear and/or a recognition characteristic of a body of water below the aircraft.

16. System for controlling an aircraft component during a water landing of an aircraft, comprising:
at least one detection device, which is adapted to detect at least one signal suitable for recognizing an imminent water landing of the aircraft,
a control unit, which is adapted to receive the at least one signal and to evaluate said signal on the basis of at least one predetermined recognition characteristic that characterizes a water landing of the aircraft, and which is further adapted to control a closing device associated with an opening in such a way that in the event of a water landing of the aircraft the entry of water into an interior area of the aircraft through the opening is prevented if the control unit recognizes that a water landing of the aircraft is imminent on the basis of the at least one signal and the at least one recognition characteristic.

17. System according to claim 16,
characterized in that the control unit is further adapted to control a pressure generating system of the aircraft in such a way that a pressure build-up in an aircraft area that is pressurized during normal operation of the aircraft is prevented if the control unit recognizes that a water landing of the aircraft is imminent.

18. System according to claim 16,
characterized in that the control unit is adapted to recognize that a water landing of the aircraft is imminent on the basis of at least two recognition characteristics that characterize an imminent water landing of the aircraft, wherein the at least two recognition characteristics differ from one another.

19. System according to claim 16,
characterized in that the signal suitable for recognizing an imminent water landing of the aircraft is a signal that is characteristic of the actual cruising altitude of the aircraft, a signal that is characteristic of the ambient pressure, a signal that is characteristic of the operating state of aircraft landing gear and/or a signal that is characteristic of the nature of the earth's surface below the aircraft.

20. System according to claim 16,
characterized in that the predetermined recognition characteristic that characterizes a water landing is a recognition characteristic of a drop below a predetermined cruising altitude of the aircraft, a recognition characteristic of a rise above a predetermined ambient pressure, a recognition characteristic of retracted aircraft landing gear and/or a recognition characteristic of a body of water below the aircraft.
